(19) United States
(12) Patent Application Publication
(10) Pub. No.: US 2025/0121658 A1
(43) Pub. Date: Apr. 17, 2025

(54) Vehicle With a Frameless Vehicle Door

(71) Applicant: Bayerische Motoren Werke Aktiengesellschaft, Muenchen (DE)

(72) Inventors: Gernot FRENER, Muenchen (DE); Peter LOCHBRUNNER, Muenchen (DE)

(21) Appl. No.: 18/834,664

(22) PCT Filed: Mar. 3, 2023
(86) PCT No.: PCT/EP2023/055400

§ 371 Date: Jul. 31, 2024

(30) Foreign Application Priority Data
Mar. 8, 2022 (DE) 10 2022 105 398.9

(51) Int. Cl. B60J 1/17; E05F 11/38

(52) U.S. Cl. CPC B60J 1/17; E05F 11/382; E05Y 2201/684; E05Y 2900/55

(57) ABSTRACT

A vehicle with a frameless vehicle door having a lower door body and a moveable door window pane, wherein a respective guide rail is curved around the same axis as the door window pane in parallel with the unloaded door window frame, and the curvature and/or the position of the guide rails relative to the door body deviate from a constructional class A surface curvature and/or a class A surface spatial positioning, are configured such that, in an unloaded state extended out of the door body, the door window pane has a first spatial form and/or adopts a first spatial position which deviates from a constructionally determined door window pane class A surface spatial form and/or door window pane class A surface spatial position, and in a loaded state, the door window pane has a second spatial form and/or adopts a second spatial position which substantially corresponds with the door window pane class A surface spatial form and/or door window pane class A surface spatial position.

### TECHNICAL FIELD

The invention relates to a vehicle, in particular a motor vehicle, having a frameless vehicle door. Specifically, the invention relates to an improved door window in a frameless vehicle door, the door window being able to be moved into and out of the vehicle door. Furthermore, the invention relates to a method for closing a door window opening in a vehicle in an aerodynamically optimized tight, in particular watertight, manner.

### BACKGROUND AND SUMMARY

The window lifter kinematics of frameless vehicle doors are extremely complex, and so problems with watertightness and aeroacoustics occur more frequently than in vehicle doors with frames. The reason for the great complexity is the lack of a window frame, meaning that the door window pane, which protrudes freely upward out of the door body in the extended state, has to perfectly match the door sealing system in all tolerance situations, in order to satisfy both the sealing requirements and the endurance requirements of all the components.

In the closed state of the vehicle door, the door sealing system of the vehicle applies a force that is directed toward the vehicle door and the door window pane, in order to seal the vehicle door including the door window pane in the closed state. This sealing force has the result, specifically in the region of the door window pane above the shoulder of the door body, that the door window pane is pushed outward and is no longer in the originally constructed position.

This results in a number of problems in conventional constructions. Firstly, the pane deviates visually from the constructed position, with the result that it is possible to see on the vehicle with the door closed that the door window pane of the door is not properly aligned with the other components on the door side, for example with a side window fixed to the vehicle body or a cover on the B-pillar. Moreover, this deviation also has the result that, when it moves upward, the door window pane cannot pass precisely into the sealing system in the roof frame region. This results in sealing problems in relation to aeroacoustics and in relation to watertightness. Therefore, the kinematics of the window lifter have to be designed such that the door window pane compensates for all the forces of the sealing system. The aim is that, with the door closed, the door window pane corresponds to the original class-A surfaces of the vehicle.

A class-A surface is understood to be a visible surface of a vehicle in its spatial form and spatial position theoretically defined by the construction. However, both the spatial form and the spatial position of this surface can deviate from the ideal class-A-surface spatial form when a component is produced in practice, for example on account of forces acting on the component surface.

The kinematics of a window lifter of frameless vehicle doors are conventionally embodied with two guide rails. The rail is constructed on the basis of the curvature of the pane class-A surface. Normally, this is done by the axis of curvature for the guide rail corresponding to the axis of curvature of the class-A-surface pane surface. Consequently, while it is being moved, the door window pane always moves on the same extended curved path or area, the so-called “window curvature”. In the closed state of the door window pane, the latter is pushed outward by the sealing forces acting thereon, however.

In order to compensate for these sealing opposing forces, an inward bend toward the vertical vehicle longitudinal center plane is usually frequently provided on a guide rail—in the case of front vehicle side doors this is usually the rear guide rail—in the upper region of the guide rail, forcing the door window pane into the rear region while it is moving up, to tilt it inward. As a result, a preload arises at each seal, this preload being intended to compensate for the sealing opposing forces. However, since this bend is only provided on the rear guide rail, but the front guide rail corresponds exactly to the pane curvature, the kinematics of the window lifter are overdetermined. The door window pane is twisted, and tension arises in the entire system. This results in an undefined position of the door window pane. The deformation pattern depends on the equilibrium of forces and thus on the stiffness of all the components involved (door window pane, window lifter, door panel, seals). This makes it extremely difficult to specifically influence the position of the side window in order to compensate for example for tolerances that arise.

EP 0 201 343 A2 shows and describes a vehicle door having window lifter kinematics in which the door window pane is provided at the top and bottom with sliding mounts that are each provided with a guide lug, these engaging in the uniformly curved guide rails and being guided therein. The upper and lower sliding mounts have different sizes, with the result that the door window pane is guided further out in its lower region than in its upper region; the door window pane is thus positioned in a wedge shape, and so the plane of curvature of the door window pane differs from the plane of curvature of the guide rails.

DE 10 2019 215 093 B2 shows and describes a window lifter in a vehicle door, wherein at least one of the guide rails is mounted on the door structure, in the upper region of the guide rail, with a pivotable fastening device.

DE 10 2018 000 868 A1 shows and describes a vehicle door having a height-adjustable window pane which is guided above the door shoulder in a door window frame in such a way that the outer surface of the window pane extends flush with the vehicle body surface (flush glazing).

DE 28 43 004 A1 relates to a vehicle door having window lifter kinematics, wherein the door window pane is guided above the door shoulder in a door window frame such that, here too, a flush-glazing effect is achieved. The door window pane is in that case guided in such a way that its upper edge executes an S-shaped outward movement before entering the roof-side seal.

The object of the present invention is to improve a generic vehicle, in particular a corresponding frameless vehicle door, such that, in the closed state of the vehicle door, not only is the door window pane effectively sealed, but also the deviations of the spatial form and spatial position of the door window pane relative to the door body from the spatial form and the spatial position of the associated class-A surface relative to the door body are minimized. Finally, the invention is also intended to provide a corresponding method for closing a door window opening of a vehicle in an aerodynamically optimized tight and in particular watertight manner.

The object directed to the vehicle and in particular to the vehicle door is achieved by the features of the independent claim(s).

A vehicle, in particular a motor vehicle, is equipped with a vehicle body which has at least one frameless vehicle door which has a lower door body and a door window pane that is able to be moved upward out of the door body and back into the latter by means of a window lifter unit, wherein the door body is designed to be frameless above a door shoulder that upwardly delimits the door body, wherein the door shoulder has a passage slot, preferably provided at its longitudinal edges with seals, for the door window pane, wherein, when it is in the state extended fully out of the door body and with the vehicle door closed, the door window pane bears, at least with its first lateral pane edge, against a first seal on the vehicle body and, with its second lateral pane edge, against a second seal on the vehicle body, and wherein the door window pane is curved toward the vertical vehicle longitudinal center plane. In this vehicle, the invention provides that each guide rail is curved parallel to the unloaded door window pane, in the region of the latter guided by the guide rail, and about the same axis as the door window pane, and that the curvature and/or the position of the guide rails relative to the door body deviate from a constructional class-A-surface curvature and/or class-A-surface spatial position of the guide rails relative to the door body and are designed or arranged in such a way that, when it is in an unloaded state extended out of the door body, the door window pane forms a first spatial form and/or takes up a first spatial position relative to the door body, which deviates from a constructionally fixed door-window-pane class-A-surface spatial form and/or door-window-pane class-A-surface spatial position relative to the door body, and that, when it is in an unloaded state, in which the pane edges bear against the respectively associated seal, the door window pane forms a second spatial form and/or takes up a second spatial position relative to the door body, which corresponds substantially to the door-window-pane class-A-surface spatial form and/or door-window-pane class-A-surface spatial position relative to the door body. Substantially means here that insignificant deviations from the class-A-surface spatial form that are not visible to the naked eye are permissible.

The “axis of curvature” of the door window pane is understood here to be an axis which has a main direction component extending in the vehicle longitudinal direction and on which all the center points of the radii of curvature of the door window pane lie along their extension in the vehicle longitudinal direction. During a movement of the door window pane between its position lowered into the door body and its position extended out of the door body, the door window pane rotates about this axis of curvature and at the same time moves along this axis of curvature. In the process, it describes a screw-like area, which is referred to in simplified terms as “window curvature”. The surface of the door window pane is preferably curved with different radii of curvature along its longitudinal extent, wherein the center point of each radius of curvature lies on the axis of curvature and this radius of curvature extends orthogonally to the axis of curvature. Where “a radius of curvature” is referred to here, this choice of words always relates to a local radius of curvature and the corresponding statements relate to all radii of curvature.

The radius of curvature of the rail results from the radius of curvature of the pane at the location of the pane guide, because both curved geometries have the same axis of curvature (screw axis). Since, however, the rails are usually located further toward the inside of the vehicle, i.e. exhibit a certain offset with respect to the pane, the radius of curvature of the rail is smaller by this offset than the radius of curvature of the pane. The radius of curvature of the door window pane is not necessarily constant in the vehicle longitudinal direction and may vary from front to rear.

If the vehicle has a roof or a roof rail delimiting the door window opening, or if, in the case of a convertible, the roof is closed, the door window pane additionally bears, in its state extended fully out of the door body and with the vehicle door closed, with its upper pane edge against a roof-side seal, which likewise exerts an outwardly directed sealing force on the door window pane. This sealing force also needs to be taken into consideration in the design of the vehicle according to the invention.

An “unloaded door window pane” is considered here to be a door window pane of a frameless vehicle door, which has been extended out of the door body—preferably until abutment—and yet does not bear against the seals on the vehicle body, for example on the B-pillar or in the roof frame. This is the case when no door window seals (on the vehicle body and door) have been installed. This state is also referred to as “unloaded state”.

A “loaded door window pane” is considered here to be a door window pane of a frameless vehicle door, which has been extended out of the door body—preferably until abutment at the top—and bears against the seals on the vehicle body. This state is also referred to as “loaded state”.

The described construction results in the creation of a spatial form and/or spatial position of the door window pane which, in the closed state, forms different preloads at different points of the door window pane, for example different preloads on the A-pillar at the top and at the B-pillar at the top.

In the case of a spatial form of the door window pane that differs according to the invention from the class-A-surface spatial form, the position of the axis of curvature of the door window pane in the unloaded state can differ from the position of the axis of curvature of the class-A-surface spatial form, which the door window pane approximates in the loaded state.

When the door is closed, the door window pane bearing against the seals (and, together therewith, also the window lifter unit with the guide rails) is loaded by the opposing forces of the sealing system. As a result, the previously preloaded pane is brought into the desired class-A-surface spatial form and/or door-window-pane class-A-surface spatial position. If, with the door closed, the door window pane is moved upward out of the door body, the pane is pushed slightly outward right from the start on account of the seals along the B-pillar, such that, with the door closed, the door window pane and, together therewith, the entire window lifter system, which has the window lifter unit with the guide rails and the door window pane guided therein, is substantially unloaded only in the fully lowered state of the door window pane.

According to the invention, preloading of the door window pane with respect to the door sealing system is created only when the door window pane bears against the seals, in particular in the upper region of the lateral seals and optionally against the roof-side seal, without the entire window lifter system already being intrinsically under tension. This is achieved in that the spatial form and/or the spatial position of the door window pane deviates, in the unloaded state, from the spatial form and/or the spatial position of the associated class-A surface, and the door window pane takes up the spatial form and/or the spatial position of the class-A surface only with the opposing force of the sealing system. The basic principle of the invention is thus the avoidance of overdetermination and a resultant forced position of the window lifter system.

An essential advantage of the invention is that a preloaded door window pane surface is created, which, in the unloaded state, remains in its own curved area (window curvature) while it is being moved. This preloaded door window pane surface preferably takes into consideration different preload values at different points on the edge of the door window pane in the region of the A-pillar and in the region of the B-pillar with respect to the constructional class-A surface of the door window pane.

In conventional window lifter systems for frameless vehicle doors, it has hitherto been conventional, when constructing the window lifter kinematics, to use the constructional, curved class-A surface (class-A-surface window curvature) as the movement surface of the door window pane as the basis for the design of the kinematics. In such previous systems, the kinematics are not constructed on the basis of a preloaded surface, but on the basis of the original class-A surface. Thus, a preload has to be applied afterwards in order to compensate for the sealing forces that arise and to obtain to some extent the desired class-A-surface position of the door window pane in the closed state. In previous systems, this preloading is embodied either with wedge-shaped sliders or by adjustment of the guide rails or a geometric modification of the rails, for example a bend in the upper region of each guide rail. As a result, the kinematics of the door window pane are no longer constant and thus not exact. Such a conventional door window pane does not always move on its own area (window curvature) when it is moved. Tensions arise in the system and undesired deviations of the pane position arise at the level of the shoulder and in other regions. The result may be a lack of sealing and deviations from the original class-A surface.

These drawbacks of the prior art are overcome by the invention. According to the invention, by contrast, a novel kinematic window curvature is established, which deviates in terms of its geometry (spatial form and spatial position) from the constructional class-A-surface window curvature. This novel kinematic window curvature is now used for the construction of the window lifter kinematics, with the result that the desired geometric preload values of the window lifter system and in particular of the door window pane are achieved.

The window lifter rails are also constructed on the basis of this preloaded door window pane surface, with the result that the door window pane always travels exactly through the same line of the exit slot in the door shoulder. As a result, the manufactured components (window lifter rails and door window pane) and the kinematics thereof deviate in terms of their spatial form from the original class-A surface (class-A-surface window curvature) and the kinematics that go therewith.

Further preferred and advantageous design features of the vehicle according to the invention are the subject matter of the dependent claims.

Preferably, the curvature of the region, guided by each guide rail, of the door window pane is curved, in the unloaded state of the latter, in each case about an axis of curvature which has at least one direction component extending substantially parallel to the passage slot. Door window panes curved in such a way are nowadays provided at least in side doors in many vehicles instead of simple planar door window panes. For example, the door window pane may be curved toward the vertical vehicle longitudinal center plane at least about an axis of curvature extending substantially parallel to the passage slot in side view (of the vertical vehicle longitudinal center plane EZX).

It is also advantageous when the door window pane, in the unloaded state, has substantially the same curvature as the class-A-surface spatial form, but its spatial position deviates from the class-A-surface spatial position. The term “substantially” means in this connection that the curvature of the door window pane deviates only negligibly from the class-A-surface curvature, without the sealing action being eliminated or effectively reduced.

Preferably, as an alternative, the radius of curvature of the door window pane about the axis of curvature extending substantially parallel to the passage slot in side view (of the vertical vehicle longitudinal center plane EZX) is smaller in the unloaded state of the door window pane than the radius of curvature thereof in the loaded state. This embodiment makes it possible for the pressure forces exerted on the door window pane by each seal, in particular by the roof-side seal, to reduce the curvature or concavity of the door window pane and thus to approximate the spatial form thereof to the spatial form of the associated class-A surface. In the loaded state, the door window pane therefore takes on the class-A-surface spatial form. The term “substantially” means in this connection that the axis of curvature does not need to extend exactly parallel, but may deviate from the parallel by a few degrees, for example by up to +/−20° or preferably by up to +/−10° or more preferably by up to +/−5°.

It is also advantageous when the seals on the vehicle body each have a curved course which corresponds to the curvature of the associated pane edge of the door-window-pane class-A-surface spatial form. As a result, ideal preloading of the seals with respect to the door window pane is established.

In a preferred development of the invention, the door window pane, in addition to the curvature about the axis of curvature with the direction component extending substantially parallel to the passage slot, is also curved at least regionally toward the vehicle longitudinal center plane about a substantially vertical axis of curvature, wherein the radius of curvature of the door window pane about the substantially vertical axis of curvature is smaller in the unloaded state of the door window pane than in the loaded state. The door window pane bent spatially in this way may be preloaded about the second, substantially vertical axis of curvature in the same way as was described above in relation to the first, substantially horizontally extending axis of curvature.

It is particularly advantageous here when the course of the curvature of each guide rail is constant.

In this window lifter system provided according to the invention, the door window pane travels under no tension on a movement path defined by the—preferably constant—curvature of the guide rails, which corresponds to the local curvature of the door window pane in the region of each guide thereof. The resultant areal movement-path envelope of the door window pane is not identical to the constructionally provided window curvature of the class-A-surface spatial form, but rather curved or directed inward to a greater extent than the latter. The door window pane is thus brought along the movement path, without being twisted or deformed in some other way, into respective positions which each deviate from the constructionally defined class-A-surface spatial form, such that the door window pane forms a defined preload with respect to the sealing system.

In this case, while the door window pane is being moved, the door window pane should maintain a constant lateral distance, in the region of its passage through the door shoulder, i.e. in the passage slot, from each edge of the passage slot, this distance also corresponding to the respective distance of the class-A-surface spatial form of the door window pane from the associated edge of the passage slot.

As a result, the preloading, achieved by this configuration according to the invention, of the door window pane is not identical at all points along the movement path. Thus, as a result of the predefined curvature of the door window pane and of the guide rails and as a result of the spatial positioning of the window lifter system at the height of the door shoulder, less preloading is achieved than in the region of the roof-side seal. Different preload values along the vertical course of the seal are also realized in the region of the lateral seals on the vehicle body, in particular in the region of the A-pillar and the B-pillar in the case of a side door. The different pressure forces, brought about as a result at different locations on the door window pane, of the respective seals result in deformation, which is able to be determined in a controlled manner, of the door window pane in the closed state of the latter, such that the spatial form of the door window pane in this state approximates the spatial form of the associated class-A-surface spatial form, ideally until they are identical.

The present invention can be used in all frameless vehicle doors. Conventional applications are, for example, coupés, convertibles, gran coupés or other vehicles with frameless side or rear doors. The use of this invention makes a substantial contribution to enhancing quality. As a result, rework expenditure, modification costs of series tools and warranty costs can be avoided.

The part of the object directed to the method is achieved by a method according to the claims.

A first method for closing a door window opening in a vehicle, configured according to the invention, in an aerodynamically optimized tight and in particular watertight manner is characterized in that the door window pane is guided on a path which is arcuate as seen in cross section through the vehicle and which is curved more strongly with respect to the vehicle longitudinal center plane at least above the door shoulder in the unloaded state of the door window pane than the arcuate course of the associated door-window-pane class-A-surface spatial form, or its spatial position deviates from the class-A-surface spatial position, in order to bring about preloading of the door window pane, determining the sealing action, in the loaded state. As a result, as the door window pane passes increasingly out of the door body, the upper edge of the door window pane travels more toward the vertical vehicle longitudinal center axis than is the case with the class-A-surface spatial form at the corresponding position.

A method for constructing the spatial form and movement path of a window lifter unit of a vehicle according to the invention is characterized in that first of all, the sealing forces that are necessary for achieving a predefined sealing action and need to act locally on the closed door window pane are determined, in that then, a load-free spatial form and/or load-free spatial position of the door window pane relative to the door body, deviating from the constructional class-A-surface spatial form and/or from the constructional class-A-surface spatial position of the door window pane relative to the door body, is determined, from which the door window pane is urged approximately back into the class-A-surface spatial form and/or class-A-surface spatial position by the local sealing forces, and in that the curvature of each guide rail is designed to be curved parallel to the load-free curvature of the door window pane in the region thereof guided by the guide rail, and about the same axis as the door window pane, such that, when it is retracted into the door body and when it is extended out of the door body, the door window pane moves along its own curved area. Thus, in the loaded state, the respective local curvature of the door window pane approximates the respectively associated local curvature of the class-A-surface spatial form.

This procedure when constructing a window lifter system for a lateral door window pane of a vehicle according to the method according to the invention has the result that, during the opening and closing operation, in which the door window pane bears against the seals, the position of the door window pane along the course of the passage slot always corresponds to the course of the door-window-pane class-A-surface spatial form along the course of the passage slot. In order to achieve this, the upper pane edge of the door window pane, which, in the unloaded state, moves away from the door-window-pane class-A-surface spatial form toward the vehicle longitudinal center plane as the closing movement continues, is displaced, in the loaded state, in particular when approaching the roof-side seal, toward the door-window-pane class-A-surface spatial form by the laterally outwardly directed spring forces of the seals, in particular of the roof-side seal, with deformation of the door window pane. The preloading, achieved as a result, of the door window pane on bearing against the seals, in particular against the roof-side seal, brings about, particularly in the upper region of the door window pane, a high pressure force, counteracting the sealing force, of the door window pane, with the result that the door window pane is forced. i.e. tensioned, into a spatial form, the radius of curvature of which is greater than in the unloaded state of the door window pane, resulting in turn in a shallower curvature course of the door window pane, such that the position of the door window pane in the closed, loaded state approximates the position of the associated class-A-surface spatial form. By contrast, in the region of the passage slot, the door window pane remains in its position, which in this case corresponds to the position of the associated class-A-surface spatial form. In this ideal case, the door window pane then takes on the spatial form of its class-A-surface spatial form in the closed state.

The core idea of this invention is thus that of constructing a window lifter system with a door window pane, which system, when the door window pane passes out of the door window pane, already results in a deviation with respect to the class-A-surface spatial form and/or the class-A-surface spatial position and brings about predefined preloading of the door window pane by the sealing forces. This preloading is different at different points on the door window pane. The guide rails are constructed on the basis of this novel preloaded pane surface. These rails perfectly match the novel pane surface and do not include a bend in the upper region, i.e. have no point of discontinuity, and have a constant curvature. Thus, the pane can travel into the topmost position without being intrinsically twisted or tensioned, and has the desired preload with respect to the sealing system.

Preferred exemplary embodiments of the invention with additional design details and further advantages are explained and described in more detail in the following text with reference to the appended drawings.

### BRIEF DESCRIPTION OF THE DRAWINGS

FIG. 1 is a side view of a vehicle according to an embodiment of the invention;

FIG. 2 shows a left-hand side door, illustrated in partial section, of the vehicle from FIG. 1 with a window lifter unit; and

FIG. 3 is a vertical section through the window lifter unit in a first embodiment of the invention along the line III-III in FIG. 2.

### DETAILED DESCRIPTION OF THE DRAWINGS

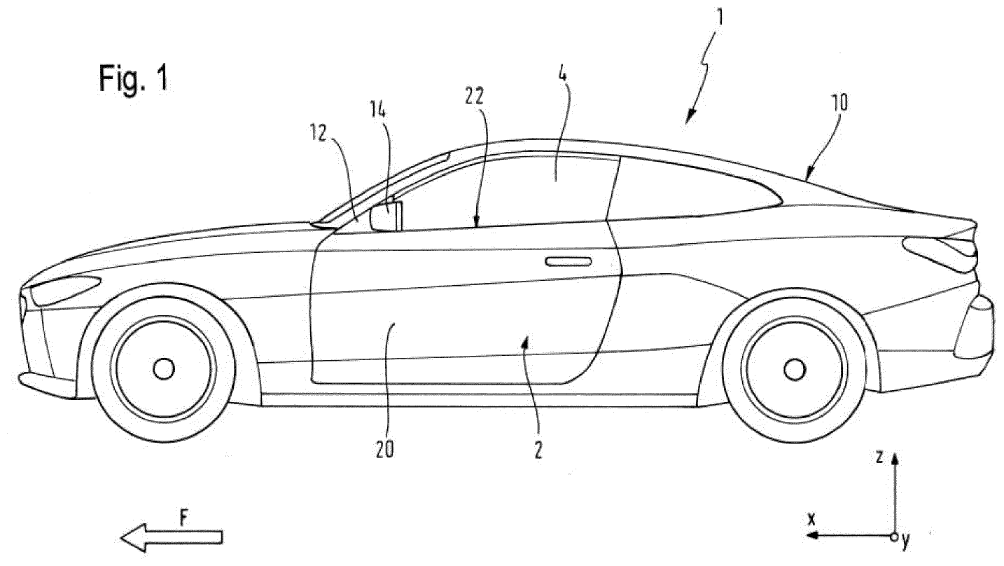

FIG. 1 shows a side view of a two-door coupé vehicle 1 having a vehicle body 10, which, in the example shown, has a vehicle side door 2 on each side of the vehicle, each door closing a door opening 11 in the vehicle body 10. The invention is not limited to two-door vehicles, however, but can also be realized in four-door or other multi-door vehicles. Moreover, the invention is not limited to vehicle side doors, but can likewise be realized in rear doors.

The vehicle door 2 has a movable door window pane 4, which closes a door window opening 11, and a lower door body 20, which is usually made from metal or plastic and in which conventional mechanical devices such as, for example, door hinges, door handle, lock and also a window lifter system 3 comprising a window lifter unit 30 and guide rails 32, 34 for the door window pane 4 are provided. The upper edge of the door body 20 forms a door shoulder 22, which has, on its top side, a passage slot 24, extending in the vehicle longitudinal direction X, for the door window pane 4.

The door window pane 4 is able to be moved upward out of the door body 20 and back into the latter by means of the window lifter unit 30, to which end a mechanical or electric drive unit 31 is provided, which drives a window lifter unit 30 and which is well known to a person skilled in the art and will therefore not be described in more detail. The window lifter unit 30 is also well known to a person skilled in the art and will therefore not be described specifically.

The lower door body 20 is designed to be frameless above the door shoulder 22, such that the door window pane 4 that has passed upwardly out of the door body 20 extends freely above the door shoulder; at most, a so-called mirror triangle 12 for mounting an exterior mirror 14 is provided in the region of the vehicle door 2 that is at the front in the direction of travel F, the mirror triangle having, on its rear side (facing the window opening 11), a short rail guide 13 for the door window pane 4.

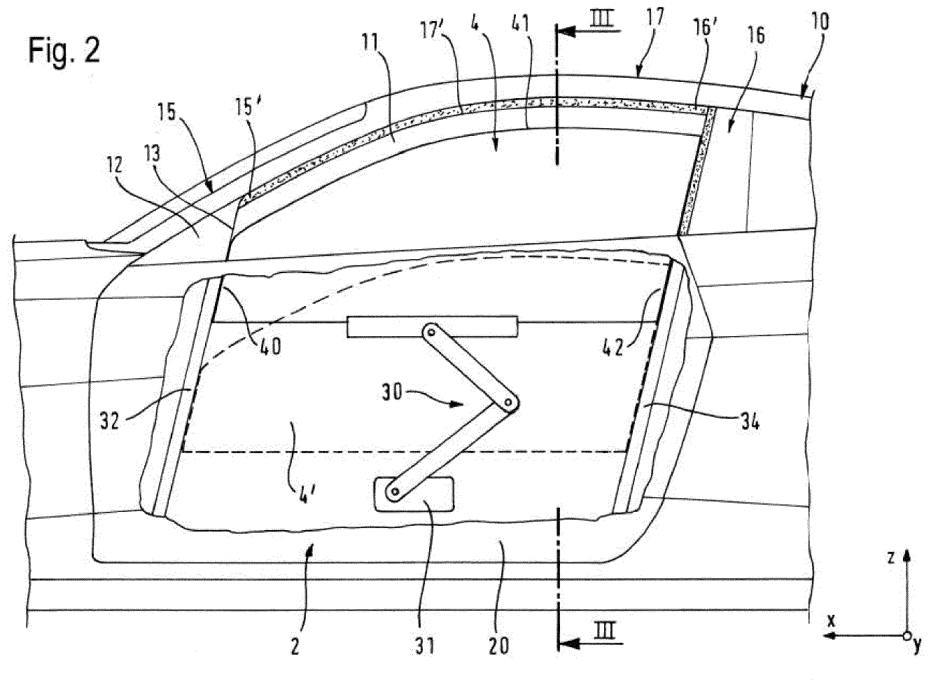

FIG. 2 shows the vehicle door 2 from FIG. 1 in an enlarged illustration that is partially in section in the region of the lower door body 20. In this illustration, the door window pane 4 has not fully passed out upward, and so the door window opening 11 in the vehicle body 10 is partially open. As a result, there is a free view of the seals which are provided on the vehicle body and against which the door window pane 4 bears in its closed state and which seal off the interior of the vehicle body from the external environment of the vehicle 1. A seal 15′ at the front in the direction of travel F is provided in the region of the A-pillar 15 of the vehicle 1, a seal 16′ at the rear counter to the direction of travel F is provided in the region of the B-pillar 16 of the vehicle body 10, and an upper seal 17′ is provided in the region of the vehicle roof 17 of the vehicle body 10. These window seals 15′, 16′, 17′ can be in the form of a single sealing component and determine portions in this sealing component. However, it is also possible, for example in a convertible, for the window seals 15′, 16′, 17′ each to be individual components.

In FIG. 2, dashed lines show the door window pane 4 in its retracted position, in which it is accommodated fully in the interior of the lower door body 20. The door window pane 4 is moved and guided in a first guide rail 32 and a second guide rail 34 by means of sliders (not illustrated) which are fastened to the door window pane 4 and which engage in the respective guide rail. Even though, for the sake of simplicity, FIG. 2 illustrates guide rails which respectively guide the front pane edge 40 and the rear pane edge 42 of the door window pane 4, the arrangement of the guide rails 32, 34 can also take up any other position that is known to a person skilled in the art in the interior of the door body 20.

Together with the guide rails 32, 34 and the drive unit 31 of the window lifter unit 30, the window lifter unit 30, which is indicated only schematically as a lever mechanism in FIG. 2, forms the window lifter system 3; it is also possible for the door window pane 4 to be considered functionally as belonging to the window lifter system 3.

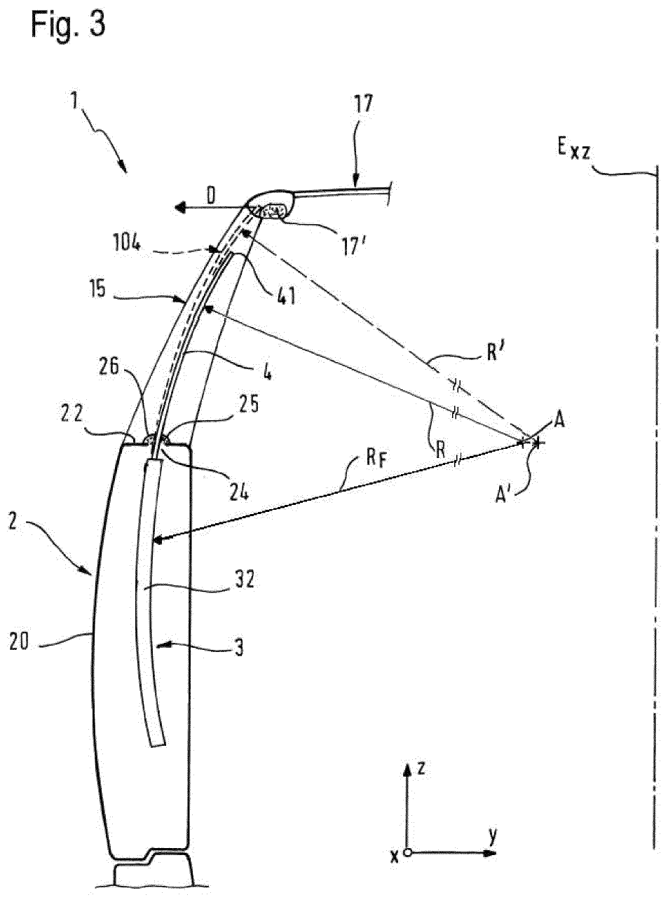

FIG. 3 shows a simplified illustration of a vertical section through the vehicle door 2 in a vertical vehicle transverse plane EYZ. In this illustration, the passage slot 24 in the upper door shoulder 22 of the door body 20 can be seen, and it is also apparent that the passage slot 24 is equipped at its longitudinal edges with an inner seal 25 and an outer seal 26, which bear against the inside and the outside of the door window pane 4 passing out of the lower door body 20. In FIG. 3—as in FIG. 2—the door window pane 4 has not passed fully out of the lower door body.

In this first exemplary embodiment of the invention, the door window pane 4 is curved about an axis of curvature A that is situated toward the vehicle longitudinal center plane EXZ, extends substantially parallel to the passage slot in side view (looking toward the plane EXZ) and has a radius of curvature R. This curvature with the radius R continues, on the basis of the axis of curvature A, as the radius RF of the guide rail in the interior of the lower door body 20 into the guide rails 32, 34 situated there, of which only the first guide rail 32 at the front in the direction of travel can be seen in FIG. 3. The curvature with the radius R about the axis of curvature A is constant and uniform, and so the curved door window pane 4 is guided substantially without tension in the guide rails.

In FIG. 3, a dashed illustration shows a class-A-surface spatial form 104, which corresponds to the window area, defined by the construction, of the door window pane 4 in its closed state. This class-A-surface spatial form 104 is intended to be taken up by the door window pane 4 when the door window opening 11 is completely closed and when the door window pane 4 bears with its upper pane edge 41 against the roof-side seal 17′ and is pushed outward by the sealing force D of the roof-side seal 17′, as is symbolized by a force arrow D in FIG. 3. It is clearly apparent from FIG. 3 that the curvature of the class-A-surface spatial form 104 is less, and so the radius of curvature R′ of the class-A-surface spatial form 104 is greater than the radius of curvature R of the unloaded door window pane 4 that is not pushed outward by the sealing force D. It is only in the region of the passage slot 24 that the end points of the radii R and R′ are the same, with the result that, at this point, both the actual position of the door window pane 4 and the position of its ideal class-A-surface spatial form 104 are identical.

The invention is not limited to the above exemplary embodiment, which serves merely as a general explanation of the core concept of the invention. Within the scope of protection, the device according to the invention can, rather, also adopt other configurations than the ones described above. In this case, the device may have in particular features that represent a combination of the respective individual features of the claims.

Reference signs in the claims, the description and the drawings serve merely for better comprehension of the invention and are not intended to limit the scope of protection.

### LIST OF REFERENCE SIGNS

1 Side view of a two-door convertible vehicle
2 Vehicle side door
3 Window lifter system
3″ Window lifter system
4 Door window pane (preloaded)
4′ Door window pane
10 Vehicle body
11 Door window opening
12 Mirror triangle
13 Rail guide on the mirror triangle
14 Exterior mirror
15 A-pillar
15′ Front seal
16 B-pillar
16′ Rear seal
17 Vehicle roof
17′ Upper, roof-side seal
20 Lower door body
22 Door shoulder
24 Passage slot
25 Inner seal
26 Outer seal
30 Window lifter unit
31 Drive unit
32 First, front guide rail
32′ First, front guide rail
34 Second, rear guide rail
40 Front pane edge
41 Upper pane edge
42 Rear pane edge
104 Class-A-surface spatial form of the door window pane
A Axis of curvature
D Sealing force
EXZ Vehicle longitudinal center plane
EYZ Vehicle transverse plane
F Direction of travel
R Radius of curvature
RF Radius of curvature of guide rail
R′ Radius of curvature
X Vehicle longitudinal direction

1.-8. (canceled)

9. A vehicle, comprising:
a vehicle body having at least one frameless vehicle door with a lower door body and a door window pane;
a window lifter unit by which the door window pane is able to be moved upward out of the door body and back into the door body,
wherein the door body is frameless above a door shoulder that upwardly delimits the door body,
wherein the door shoulder has a passage slot for the door window pane,
wherein the door window pane is guided, within the door body, by a first guide rail and a second guide rail at a distance from the first guide rail, and
wherein, when in a state extended out of the door body and with the vehicle door closed, the door window pane bears, at least with a first lateral pane edge, against a first seal on the vehicle body and, with a second lateral pane edge, against a second seal on the vehicle body,
wherein the door window pane is curved toward a vertical vehicle longitudinal center plane,
wherein each of the first and second guide rails is curved parallel to an unloaded door window pane, in a region of the latter guided by the guide rail, and about a same axis as the door window pane, and
wherein a curvature and/or position of the first and second guide rails relative to the door body deviates from a constructional class-A-surface curvature and/or class-A-surface spatial position of the guide rails relative to the door body and are configured or arranged such that:
(i) when in an unloaded state extended out of the door body, the door window pane forms a first spatial form and/or takes up a first spatial position relative to the door body, which deviates from a constructionally fixed door-window-pane class-A-surface spatial form and/or door-window-pane class-A-surface spatial position relative to the door body, and
(ii) when in an unloaded state, in which the pane edges bear against respectively associated seals, the door window pane forms a second spatial form and/or takes up a second spatial position relative to the door body, which corresponds substantially to the door-window-pane class-A-surface spatial form and/or door-window-pane class-A-surface spatial position relative to the door body.

10. The vehicle according to claim 9, wherein
the curvature of the region, guided by each guide rail, of the door window pane is curved, in the unloaded state of the door window pane, in each case about an axis of curvature which has at least one direction component extending substantially parallel to the passage slot.

11. The vehicle according to claim 9, wherein
the door window pane, in the unloaded state, has substantially the same curvature as the class-A-surface spatial form, but its spatial position deviates from the class-A-surface spatial position.

12. The vehicle according to claim 10, wherein
the radius of curvature of the door window pane about the axis of curvature extending substantially parallel to the passage slot in a side view is smaller in the unloaded state of the door window pane than the radius of curvature thereof in the loaded state.

13. The vehicle according to claim 9, wherein
the seals on the vehicle body each have a curved course which corresponds to the curvature of the associated pane edge of the door-window-pane class-A-surface spatial form.

14. The vehicle according to claim 9, wherein
the course of the curvature of each guide rail is constant.

15. A method for closing a door window opening in a vehicle in an aerodynamically watertight manner, the method comprising:
guiding the door window pane on a path which is arcuate, viewed in cross section through the vehicle, and which is curved more strongly with respect to a vehicle longitudinal center plane at least above a door shoulder in an unloaded state of the door window pane than an arcuate course of an associated door-window-pane class-A-surface spatial form, or its spatial position deviates from the class-A-surface spatial position, in order to bring about preloading of the door window pane, determining a sealing action, in the loaded state.

16. A method for constructing a spatial form and movement path of a window lifter unit of a vehicle, the method comprising:
determining sealing forces required to achieve a predefined sealing action, which sealing forces act locally on a closed door window pane;
determining a load-free spatial form and/or a load-free spatial position of the door window pane relative to a door body, deviating from a constructional class-A-surface spatial form and/or from a constructional class-A-surface spatial position of the door window pane relative to the door body, from which the door window pane is urged back into the class-A-surface spatial form and/or class-A-surface spatial position by the local sealing forces; and
configuring a curvature of each of a first and second guide rail to be curved parallel to a load-free curvature of the door window pane in a region thereof guided by the guide rail, and about a same axis as the door window pane, such that, when the door window pane is retracted into the door body and when the door window pane is extended out of the door body, the door window pane moves along its own curved area.
